(19) United States
(12) Patent Application Publication
(10) Pub. No.: US 2007/0216616 A1
(43) Pub. Date: Sep. 20, 2007

(54) Display Device Comprising A Light Source

(75) Inventors: Jeroen Hubert Christoffel Jacobus Stessen, Eindhoven (NL); Maksym Demchenko, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,506

(22) PCT Filed: May 24, 2005
(86) PCT No.: PCT/IB05/51678

§ 371 Date: Nov. 22, 2006

(30) Foreign Application Priority Data
Jun. 1, 2004 (EP) 04102435.7

(51) Int. Cl. G09G 3/34

(52) U.S. Cl. 345/84

(57) ABSTRACT

A display device (DD) comprises a light source (LS); a display panel (DP) with display pixels for modulating light originating from the light source (LS); and processing circuitry (P) coupled to the display panel (DP) and the light source (LS). The processing circuitry (P) has an input for receiving an input signal (V1) representing gray levels of pixels of an image to be displayed on the display panel (DP) and comprises: an amplifier (A) for amplifying the input signal (V1) to provide an output signal (V2) for driving the display pixels, a detector (S) for detecting whether within a part of the image a property of the output signal (V2), and—control circuitry (CM) for controlling a gain of the amplifier (A) and a brightness level of the light source (LS) in dependence on the property. The property may be that a first number of pixels of the output signal (V2) exceed a first predetermined number, wherein the first number of pixels is the number of pixels having a gray level exceeding a first predetermined gray level.

The invention relates to a display device comprising a light source, a display panel with display pixels for modulating light originating from the light source, and processing means coupled to the display panel and the light source. The invention also relates to a method of adjusting a light source of a display device, a product comprising the display device, an integrated circuit and a computer program product for enabling a programmable device to carry out the method.

EP 1,367,558 A2 discloses a display device with a Liquid Crystal Display (LCD) panel and a backlight as light source. The luminance of the backlight is adjustable. The adjusting of the backlight is correlated with adjustments of the luminance of the LCD panel. For each frame of an input signal representing display data, the values of the color components red, green and blue of pixels of the display data are analyzed. The highest value of the color components found within a frame is used to adjust the luminance of the backlight and the correlated adjustment of the luminance of the LCD panel. It is a disadvantage of the known display device that this adjustment requires fairly complicated processing.

It is an object of the invention to provide a display device of the kind described in the opening paragraph, which is capable of providing an adjusting of the light source and the correlated adjustment of the input signal in a relatively simple way.

The invention is defined by the independent claims. The dependent claims define advantageous embodiments.

The object is realized in that the processing means have an input for receiving an input signal representing gray levels of pixels of an image to be displayed on the display panel and comprise:

means for amplifying the input signal to provide an output signal for driving the display pixels,

means for detecting within a part of the image a property of the output signal, and

control means for controlling a gain of the amplifying means and a brightness level of the light source in dependence on the property.

The processing means operate as a feedback system. The input signal is firstly amplified and the output signal of the amplifier, being the signal provided to the display panel, is used to check the property of the output signal.

In an embodiment the property is a first number of pixels of the output signal exceeding a first predetermined number, wherein the first number of pixels is the number of pixels having a gray level exceeding a first predetermined gray level. This predetermined gray level is preferably a value close to the maximum value. If the output signal contains more than the first predetermined number of pixels with a gray level above the first predetermined level, the gain of the amplifier is reduced. If the output signal contains no or only a few pixels with a gray level above the first predetermined level, the gain of the amplifier is increased. So, a feedback loop is created which automatically sets its gain to a desired value. This desired value is the value at which only a limited number of pixels, being the first predetermined number of pixels, exceed the first predetermined level. The feedback loop sets the gain in such a way that the display panel is driven up to its maximum available transmissivity, almost independent of the maximum gray levels of the pixels of the input signal.

The light source may be adjusted by the control means, so as to partially, or preferably substantially, compensate for the changes of the gain. Especially when LCD panels are used, this is advantageous, as the panel is always driven up to its maximum transmissivity. If a bright image has to be displayed, the maximum transmissivity in combination with a maximum value of the brightness of the light source provides a bright picture on the display panel. If an image with a relatively low brightness has to be displayed, the maximum transmissivity may be maintained by increasing the gain, while at the same time the brightness of the light source is reduced to compensate for the change in brightness of the picture caused by the change in gain. This operation is also called “backlight dimming”. In this operating condition the obtainable black level of the display panel is lower, as always a small percentage of the light of the light source is leaking through the display panel even if the transmissivity of the panel is at its minimum level. A small percentage of the reduced level of the light source is smaller than the same percentage of the maximum level of the light source. So, the lowest possible brightness levels, being the levels near the black level, are improved, which implies that the contrast ratio of the panel is improved. For current display panels, for example, an improvement of the contrast ratio from 400:1 to 5000:1 is feasible.

Moreover at low brightness levels colors are reproduced more correctly, as more dark gray levels for each of the color components are available for providing combinations of color components, which result in the desired color. Also the viewing angle of the display panel is improved, as this viewing angle increases at increasing values of the transmissivity. Finally, also power is saved as, depending on the images to be displayed, the light output of the light source is reduced resulting in lower power consumption. All these benefits are obtained with a relatively simple processing, for example, by detecting a property of the output signal, such as the number of pixels with a gray level exceeding a predetermined level and by feeding back this information to control the gain of the amplifier.

The gray level may be the gray level of a signal corresponding to the brightness, but preferably it is the gray level of the color components representing the brightness and color of a pixel. If only the brightness level is used then at moderate brightness levels the situation may occur that one of the color components has high gray levels while the other components have low gray levels. The brightness is in this case still relatively low, so a relatively high gain is set. As a result, the color component with the high gray levels is clipping due to the high gain. If the feedback to control the gain of the amplifier is based on the color component with the highest number of pixels exceeding the predetermined level this clipping is avoided or at least reduced. The processing means may be formed by hardware circuits, by software or by a combination of hardware circuits and software.

The property of the output signal may be made dependent on a weighing factor, for example, a higher weight may be given to pixels with a high gray value than to pixels with a low gray value, or may be made dependent on the number of pixels exceeding the predetermined number. Alternatively, the property may be a simple binary indicator for indicating whether the gain of the amplifying means should increase or decrease.

In an embodiment the processing means further comprise white clipping reduction means. The input signal is coupled to the white clipping reduction means for reducing clipping of the input signal and an output of the white clipping reduction means is coupled to the amplifying means. So, white clipping reduction means may be coupled in series with the amplifying means. The white clipping reduction means with its embodiments are disclosed in WO 02/085037 and need no further elaboration here. Such a cascade connection allows independent dimensioning of the white clipping reduction and of the feedback loop which keeps the display panel operating near its maximum transmissivity.

Alternatively, the processing means may be further adapted to perform white clipping with the amplifying means, the detecting means, and the control means. This is based on the insight that the processing means perform an operation for white clipping (whereby the gain is reduced in case of relative large gray levels of the input signal to reduce clipping), which is similar to backlight dimming (whereby the transmissivity is maximized in case the input signal has relatively small gray levels by increasing the gain up to a point where clipping starts). Only one of the two operations has to be performed for a particular image, so either the clipping is operational for this image or the backlight dimming.

In an embodiment, the detecting means are adapted for detecting a second number of pixels of the output signal having a gray level exceeding a second predetermined gray level which is lower than the first predetermined gray level, and the control means are adapted for decreasing the gain of the amplifying means if the first number of pixels exceeds the first predetermined number and increasing the gain if the second number of pixels is below a second predetermined number. This introduces hysteresis in the feedback loop, thereby diminishing undesired fluctuations or instability of the feedback loop.

If the part of the image excludes areas having a dimension below a predetermined dimension, it is possible to exclude small details such as a small bright spot in a relatively dark image. This allows contrast improvement of this dark image by increasing the gain, thereby allowing some clipping of the small bright spot, which results in a better trade-off in terms of picture performance. Another example of areas to be excluded are subtitles. If the feedback loop would react on these subtitles, then the feedback loop would have to change the gain and the brightness of the light source each time the subtitles appear and disappear, which is undesirable. Moreover, relatively dark images would not benefit from contrast improvement by backlight dimming when subtitles are present. So, it is desirable to exclude such areas. Examples of the dimension are: a size of the area, a length, and a width of the area.

If the control means include means for restricting changes of the gain for subsequent images to be displayed, a more gradual change of the gain for subsequent images is obtained. This may be realized by a low pass filter in the feedback loop or by averaging the required changes over a number of subsequent images.

In an embodiment, the light source comprises lamps having mutually different colors, the input signal comprises color components, the control means are adapted to control the brightness level of the light source by separately controlling a brightness level of one or more of the lamps, and the processing means further comprise means for correcting the color components to substantially compensate for a color point shift of the displayed image as caused by separately controlling the brightness level of one or more of the lamps. Each of the lamps with mutually different colors may illuminate each color sub-pixel of the pixels of the display panel. Alternatively, the lamps with mutually different colors may be turned on and off sequentially, whereby the transmissivity of pixels is controlled in synchronization with the sequentially turning on and off. In this alternative there is no color filter needed. If a color filter is present, the transmissivity of corresponding color sub-pixels is controlled in synchronization with the sequentially turning on and off. Alternatively, each color sub-pixel has its own light source in the form of, for example, an LED of an appropriate color.

If the input signal comprises color components, each of the components may have its own amplifier with its own gain setting. The combination of the various gain settings and brightness level adjustments of one or more the lamps with the mutually different colors is determined so as to obtain the desired colors and brightness levels. This approach allows in, for example, an image with a high gray level of the green component to set the lamp or lamps of the light source generating a green color to their maximum value and to dim the lamps with other colors. The resulting color changes are compensated by the corresponding adaptation of the color components of the input signal. This approach improves the contrast and color saturation, while maintaining correct color reproduction.

In an embodiment, the input signal comprises color components, the detecting means are adapted to detect second numbers of pixels of the output signal having a gray level exceeding a third predetermined gray level, and the amplifying means are adapted for modifying the color components in order to reduce saturation of colors represented by the color components when a second number exceeds a predetermined second number. By reducing saturation of the input signal, the gray level of one or more of the color components is reduced. This enables to increase the gain of the amplifier further and to enhance the effect of backlight dimming.

Another way of enabling the increase of the gain is by including in the processing means soft clipping for reducing contrast of the input signal in an area of the image.

In an embodiment the brightness level of the light source is adjustable in a range between a minimum value and a maximum value, wherein part of the range is usable for adjustments by a user and another part of the range is usable for controlling the brightness level of the light source in dependence on the property. By restricting the range for backlight dimming in dependence on the property, the amount of change for subsequent images is restricted, thereby preventing undesired strong fluctuations of the brightness of the light source.

If an ambient light sensor is present for enabling the controlling of the brightness level of the light source in dependence on an ambient light level, the displayed image may be adapted to ambient lighting conditions. For example, in a bright ambient, the dimming of the light source is restricted to a range near its maximum value of the brightness, while in a relatively dark ambient, the dimming is restricted to a range near the minimum value of the brightness of the light source.

If a temperature sensor is present for enabling the controlling of the brightness level of the light source in dependence on the temperature, the available processing means may be used to control the brightness of the light source, and thereby the power consumption, in dependence on the ambient temperature of the display device. For example, if at a high ambient temperature one or more elements of the display device would, exceed their temperature rating, the light source is dimmed and/or its range of dimming is restricted, thereby reducing power consumption in order to reduce the temperature. By applying this sensor, it is possible to avoid fans and/or to allow a higher brightness at lower ambient temperatures. The sensor may sense the temperature of the ambient of the display device, but may also be located inside the display device to sense the temperature of one or more critical components such as the lamps of the light source and/or one or more other critical components.

In an embodiment the processing means comprise gamma correction means for compensating non-linear characteristics of the display device and/or of the input signal.

This enables a correct reproduction of gray levels on the display panel. The gamma correction means may compensate for the non-linear pre-correction present in the input signal, for the non-linearity of the display panel, and/or for non-linearity of driver circuits via which the output signal is coupled to the display panel.

According to an aspect of the invention the product comprises the display device according to the invention, and signal processing circuitry for providing the input signal. The product may a a television set, a monitor or another product with a display device. The display device may be an LCD device or another display device requiring a light source such as a digital mirror device. The display device may, next to a transmissive type with a backlight, also be a reflective type which reflects light from a light source or a combination of these types. The product may be a direct view product or a projector, which projects an image on a screen. The projector may be a front or a rear projector.

These and other aspects of the invention will be further elucidated and described with reference to the drawings, in which:

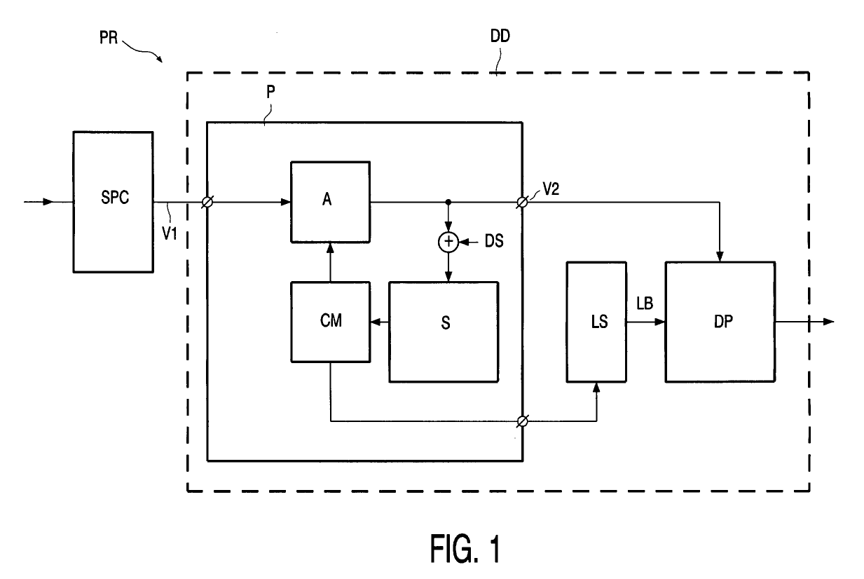

FIG. 1 shows a block diagram of an embodiment of the product according to the invention;

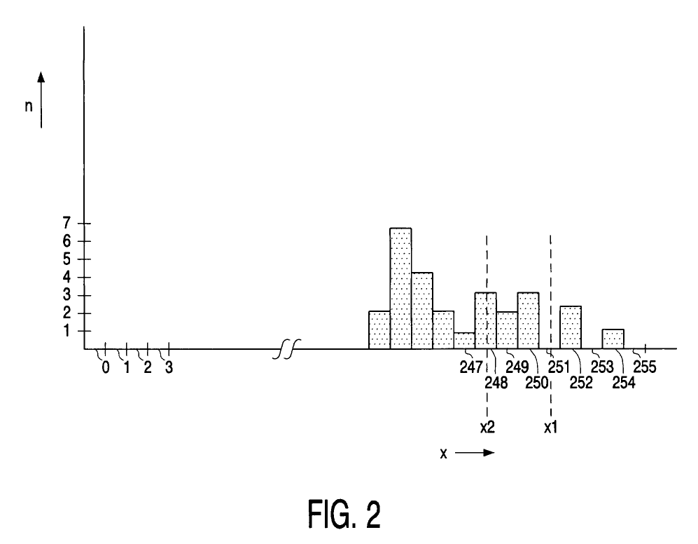

FIG. 2 shows a histogram of the gray values of the output signal;

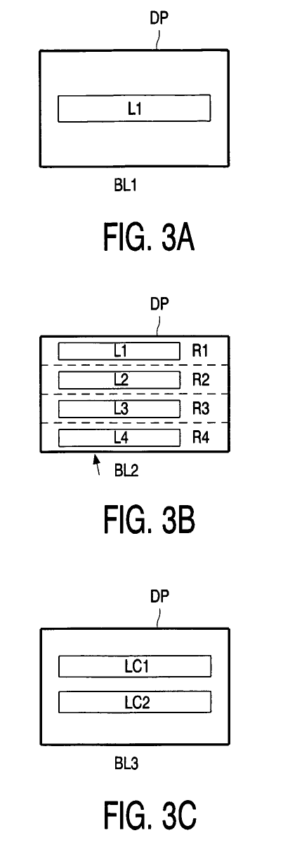

FIG. 3 shows examples of light sources;

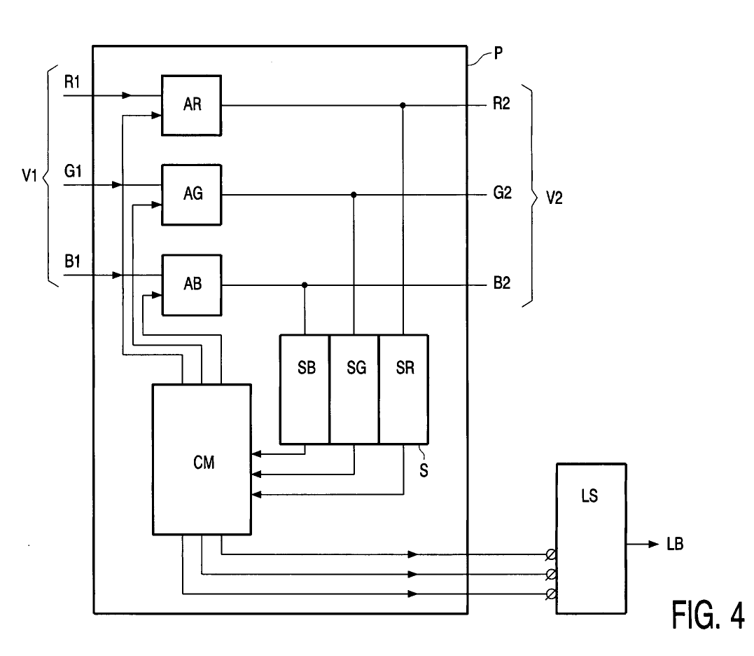

FIG. 4 shows a block diagram of an embodiment of processing circuitry;

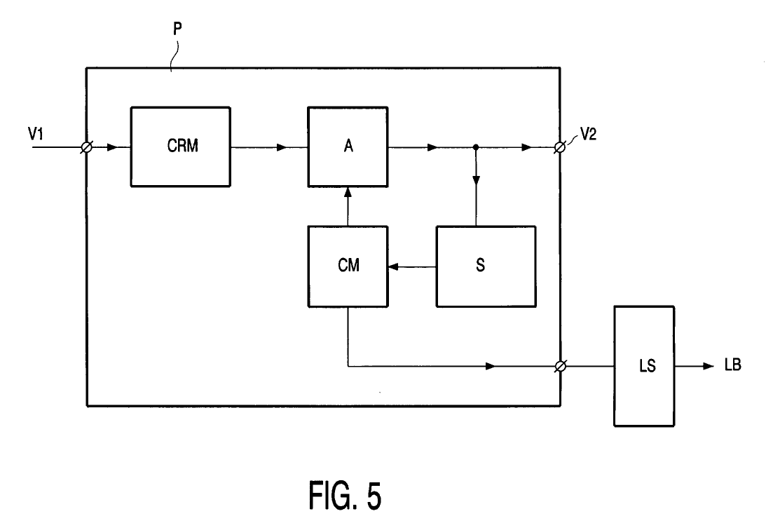

FIG. 5 shows a block diagram of an embodiment of processing circuitry including white clipping;

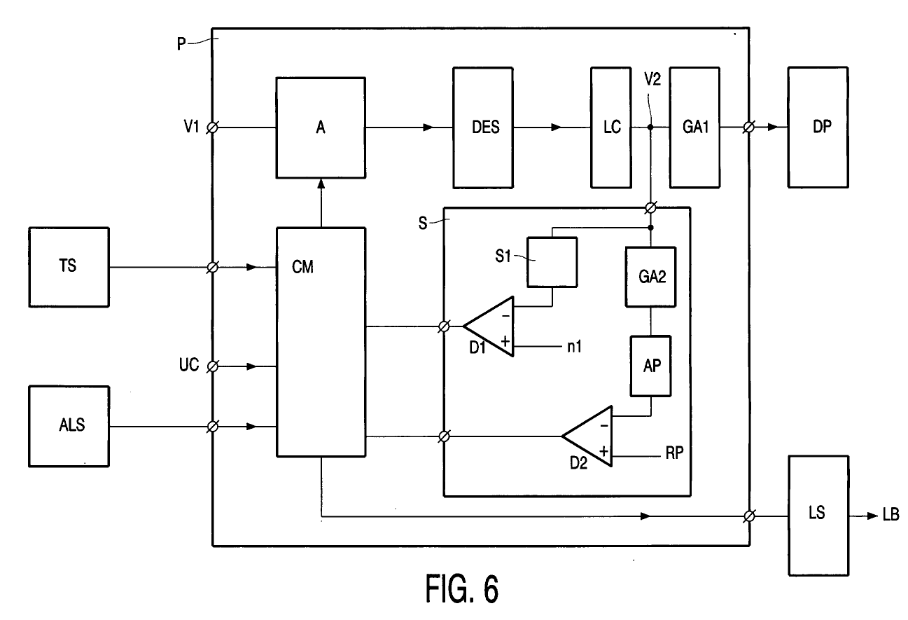

FIG. 6 shows a block diagram of another embodiment of processing circuitry including white clipping; and

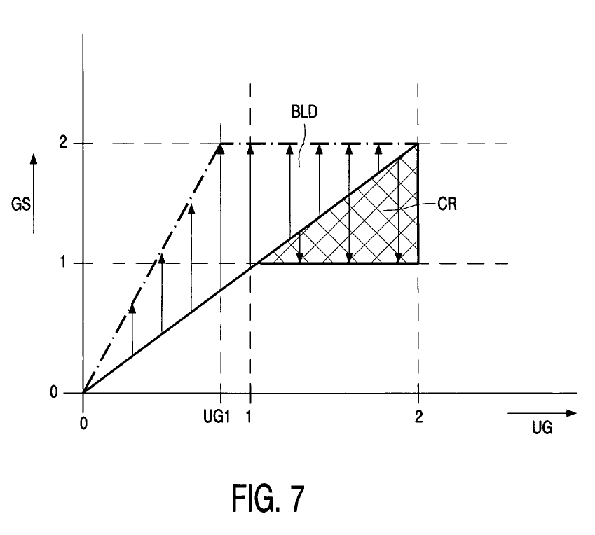

FIG. 7 shows an automatic gain setting as function of a user gain.

The same references in different Figs. refer to the same signals or to elements performing the same function.

An embodiment of a product PR comprising a display device DD and signal processing circuitry SPC is shown in FIG. 1. The signal processing circuitry SPC may receive an external input signal via an antenna input or via an external input connector for receiving signals from another product such as a computer or a DVD player or from another product, which generates images. The signal processing circuitry SPC converts the external input signal into an input signal V1 V1 adapted to an input format of the display device DD.

The input signal V1 may be analog or digital; it may represent monochrome images or color images. In case of color images, the input signal may comprise a separate luminance signal in combination with color information or may comprise color components, for example in the form of an RGB signal with a red color component R1, a green color component G1 and a blue color component B1 (as shown in FIG. 4). In case of color images, the term “gray level” is to be interpreted as an amplitude level of a color component. These gray levels or amplitude levels may be discrete levels in case of a digital input signal. For example, in case of an 8 bit digital signal 2⁸=256 gray levels or amplitude levels are possible.

For simplicity of the explanation, the principles of operation of the display device DD shown in FIG. 1, will be explained with a digital monochrome input signal V1, representing gray levels x of the pixels of the image.

The display device DD comprises an adjustable light source LS, a display panel DP with pixels for modulating light LB originating from the light source LS, and processing circuitry P. The processing circuitry P is coupled to the display panel DP and to the adjustable light source LS and has an input for receiving the input signal V1 representing an image to be displayed on the display panel DP. The image may be represented by a matrix of rows and columns of pixels. In case of a moving image (video), the input signal represents a sequence of images. In case the input signal comprises sequences of parts of images, for example, even and odd fields of a video frame or field sequential color information, then the image is to be interpreted also as one of such fields.

The processing circuitry P comprises an amplifier A for amplifying the input signal V1 resulting in an output signal V2. The output signal V2 drives the pixels of the display panel DP. This may be done via driver circuits (not shown). The output signal V2 is also coupled to a detector S. Optionally, the output signal V2 is supplied to the detector S after adding a dithering signal DS, as will be explained later on. This detector S detects within a part of the image, a property of the output signal V2. The processing circuitry P further comprises a control circuit CM for controlling the gain of the amplifier A and a brightness level of the light source LS in dependence on an output of the detector S, and, consequently, in dependence on the property.

The property may be a first number of pixels of the output signal V2 exceeding a first predetermined number, wherein the first number of pixels is the number of pixels having a gray level exceeding a first predetermined gray level. This is illustrated in FIG. 2 showing a part of a histogram indicating with vertical black bars for each possible gray level x the number of occurrences n of this gray level x for the pixels of an image represented by the output signal V2. This first predetermined gray level, indicated by x1, is preferably a value close to the maximum value. If the output signal V2 is represented by an 8-bit digital signal then 2⁸=256 gray levels x are possible, ranging from zero to 255. In such a case the maximum value is 255 and a possible value for the first predetermined gray level x1 is 251. In the example given in FIG. 2, the first number of pixels exceeding the first predetermined gray level x1 is three (two pixels with gray level 252 and one pixel with gray level 254). If the first predetermined number n1 has been set to two, then the condition is met that the first number (being three) exceeds the first predetermined number n1, being two. In this case, the gain of the amplifier is reduced. If the output signal V2 contains less than three pixels with a gray level above the first predetermined level x1, the gain of the amplifier is increased. So, a feedback loop is created, which automatically sets its gain to a desired value. This desired value is the value at which only a limited number of pixels, being the first predetermined number n1 of pixels, exceed the first predetermined level x1. A suitable value for the number n1 for this embodiment is 0.1 percent of the number of pixels in an image.

To improve the stability of the feedback loop, hysteresis may be introduced by decreasing the gain under the conditions as mentioned in above example and by increasing the gain if the number of pixels with a gray level above a second predetermined level x2, is below a second predetermined number n2. So, as illustrated in FIG. 2, if the second predetermined number n2 is set to two, then the gain is increased if none or one of the pixels of an image have a gray level above the second predetermined level x2. It has been found that x1=252 and x2=248 are suitable values for a loop with hysteresis, while the predetermined numbers n1 and n2 usually have to be higher than mentioned in the example of FIG. 2 in order to ensure stability of the loop. In general, it has to be ensured that there are enough pixels with a gray level between the first and second predetermined levels x1, x2 to obtain a stable loop. Suitable values for the numbers n1 and n2 are in a range of 0.05% to 5% of the total number of pixels in an image.

Another way of improving the stability of the feedback loop is adding some dithering DS to the output signal V2 before supplying it to the detector S as shown in FIG. 1. The dithering signal may be a random (noise) signal or a repeating sequence of values.

Preferably the control circuit CM controls the brightness level of the light LB of the light source LS so as to substantially compensate for a change in brightness of a displayed image resulting from a change of the gain of the amplifier A. For example, via a look-up table or a via a formula describing the relation between the gain and the brightness level of the display panel DP, the brightness level is determined which corresponds to the gain set by the control circuit CM as result of the output of the detector S. The described feedback loop increases the gain for images, which have no or very little pixels with a gray level near the white level and reduce accordingly the brightness of the light source LS. The result is a displayed image with an unchanged brightness level, however, due to the lower brightness level of the light source LS, the reproduction of gray levels near the black level has been improved, as there is less light leakage from the display panel DP at its minimum transmissivity (or reflectivity). This operation of reducing the brightness of the light source LS while correcting by means of the gain of the output signal V2, is also called backlight dimming. When increasing the gain of the amplifier A from, for example, one to three, the effect on the brightness of the display panel DP having a gamma of two is equal to 3²=9. In practice also the effect of any other non-linear circuits present between the amplifier A and the display panel DP, such as any further gamma correction circuitry or non-linear driver circuits, has to be taken into account, when establishing the relation between a gain change and a corresponding change of the brightness of the light source LS.

The light source LS may be a single lamp backlight unit BL1 with one lamp L1 as shown in FIG. 3A for illuminating the whole display panel DP. Alternatively, as shown in FIG. 3B, it may be a multiple lamp backlight unit BL2 with a plurality of lamps L1, L2, L3, L4, each directed to illuminate a corresponding region R1, R2, R3, R4 of the display panel DP. Each of the lamps L1, L2, L3, L4 may be dimmed simultaneously with a substantially same amount or may be dimmed separately with a different amount and/or at different moments in time. In case the regions R1, R2, R3, R4 partially overlap each other, the effect of dimming one of the lamps L1, L2, L3, L4 for a particular one of the regions R1, R2, R3, R4 may result in a change of brightness levels in another region which overlaps with this particular region. In such a case the change of brightness levels may be corrected by adapting the output signal V2, such that this adaptation counteracts the changes. If one or more of the regions R1, R2, R3, R4 correspond, for example, to a horizontal (or vertical) black bar in an image to be displayed, the corresponding lamp L1; L2; L3; L4 may be turned off completely.

Another alternative, as shown in FIG. 3C, is a multicolor backlight unit BL3 with a plurality of color lamps LC1, LC2 of different color, the color lamps LC1, LC2 directed to illuminate a same region of the display panel DP. Of course, the light source LS may also be formed by alterations (for example of number, type or positions of lamps) and/or combinations of above mentioned backlight units. The number of lamps may be equal to the number of pixels or the number of sub-pixels, where the lamps are, for example, formed by Light Emitting Diodes (LEDs) or organic LEDs (OLEDs/PLEDs). A set of sub-pixels, usually each sub-pixel being associated with a different color component, forms a pixel.

Yet another alternative (not shown) is a backlight unit, having one or more lamps providing a substantially constant brightness, wherein dimming of the light is obtained by means of a light shutter, which controls the amount of light to be passed on from the lamps to the display panel DP.

In general there are two basic options for controlling the gain of the amplifier A (which controls the amplitude of the output signal V2) in combination with controlling the light LB from the light source LS:

The first option is that the lamp or each lamp of the light source LS is receiving a common control signal, so as to simultaneously change the brightness of all the lamps present in the light source LS, thereby maintaining substantially the same color point as shown in the embodiment of FIG. 1. In this option the control circuit CM may also send a common control signal to the amplifier A for controlling the gain, so controlling the amplitude of the output signal V2. Even if the output signal V2 comprises red, green and blue color components R2, G2, B2, then the gain for each of the color components R2, G2, B2 has to be adapted with a same amount in order to maintain correct color reproduction of the image to be displayed on the display panel DP, so a common signal is sufficient.

The second option is that when changing the brightness of the light source LS, the color point of the light LB is changing. This may be a secondary effect, or may be created by having lamps with mutually different color points, which are individually controllable. In this case the control circuit CM preferably provides individual control signals to each lamp, or each group of lamps with common characteristics as shown in the embodiment of FIG. 4. The control circuit CM is further adapted to provide individual control signals for individually controlling the gain of separate amplifiers AR, AG, AB, each amplifier AR, AG, AB receiving a different color component R1, G1, B1, respectively, of the input signal V1. The control circuit CM adapts the gain of the amplifiers, so that the resulting color point change of the color components R2, G2, B2 of the output signal V2 substantially compensates the color point change of the light source LS. In this last case the detector S has sub-detectors SR, SG, SB for detecting properties of the respective color components R2, G2, B2.

If the light source LS has lamps or groups of lamps, which operate in combination with a specific color component R2; G2; B2, then each color component R2, G2, B2 with its corresponding group of lamps may be controlled with an independent, separate feedback loop in combination with an individual control signal to the corresponding group of lamps. So, in fact three separate feedback loops operate in parallel.

Alternatively, if a lamp or group of lamps operate in combination with more than one color component R2, G2, B2, then the control circuit CM determines based on a combination of the outputs of the sub-detectors SR, SG, SB how to adjust the groups of lamps and any resulting corrections of the relative gain of the amplifiers AR, AG, AB necessary to compensate for a color point change of the light source LS. In this case a calculation is required, using a 3×3 matrix for correcting each of the color components R1, G1, B1 for the color point change. This recalculation should be done in the linear light domain, so first a correction of the non-linearity (the gamma) introduced in the subsequent circuits and the display panel DP should be applied to the color components R1, G1, B1, before calculating the 3×3 matrix.

The processing circuitry P may further comprise white clipping reduction means CRM. These means may be formed by hardware white clipping circuitry, by software (meaning that the required video processing and other processing is done under control of a program running on a processor), or a combination of both. Embodiments of white clipping reduction means CRM are disclosed in WO 02/085037. FIG. 5 shows how to combine the white clipping reduction means CRM with backlight dimming as described herinbefore with respect to FIG. 1. The input signal V1 is coupled to the white clipping reduction means CRM for reducing clipping of the input signal V1. The output of the white clipping reduction means CRM is coupled to the amplifier A.

It should be noted that if the input signal V1 comprises pixels, which are having a gray level that is too high (too white) to be reproduced correctly on the display panel DP, the white clipping reduction means CRM are active to reduce the gain. The resulting white clipped output signal to the amplifier A has generally a relatively large number of pixels with a gray level near white. So the following feedback loop for backlight dimming is not active for such a white clipped signal. On the other hand for an image having pixels with a relatively low gray level (no pixels with a gray level near white), the white clipping reduction means CRM are not active, but the feedback loop for backlight dimming is active. So, depending on the image content either white clipping or backlight dimming is performed on an image, but there is no need to carry out both operations on a same image.

The embodiment of FIG. 6 is based on above mentioned observation and the fact that also the white clipping means CRM may be formed by a feedback loop similar to the feedback loop applied for backlight dimming. FIG. 6 shows one feedback loop, which operates either to perform white clipping or to perform backlight dimming. This reduces the required hardware and/or software compared to the embodiment shown in FIG. 5, while the embodiment of FIG. 5 has the advantage that the feedback loop for white clipping can be dimensioned independently from the backlight dimming loop. The input signal V1 is applied to the amplifier A that has an adjustable gain.

Optionally, a local desaturation function LD and a local contrast reduction function LC are present. The optional functions serve to reduce relatively high gray level values in relatively small areas of the image. If, for example, only one of the color components has a relatively high value in a small area of the image, then the saturation of the pixels in this area may be reduced, thereby reducing the relatively high value of the concerned color component.

Alternatively, if all of the components have a relatively high value in a small area, then the gray levels of all the color components of the pixels in this small area may be reduced. This may be done by hard clipping by clipping all gray levels above a predetermined clipping level to this level. Alternatively, this may be done by soft clipping by reducing proportionally gray levels above the predetermined clipping level to a level closer to the clipping level. When applying hard clipping or soft clipping, this may be applied directly to one color component without influencing the values of the other color components of the concerned pixels. This simple way of clipping results in discoloration. To avoid discoloration when one of the color components of a pixel is clipped, the other color components of the concerned pixel should be reduced in amplitude in proportion to the reduction of the clipped component.

With a small area is meant an area of predetermined dimensions that is less than 5% of the total image area. In an embodiment firstly in a line of an image the output signal V2 is filtered in a non-linear way: the filtered signal will reach a high level only if a sufficient number of adjacent pixels of the output signal V2 has a high gray level. If the high level pixels are frequently interrupted by low level pixels, for example as in the case of sub-titles, then the filtered output does not reach a high value. From the output of this filter, the number of pixels having a filtered output with a gray level above a predetermined clipping level are counted. If the total number of these counted pixels remains below a predetermined percentage of the total number of pixels in an image then the gain is no longer reduced, and as a result a certain amount of pixels with a high, gray level will be clipped. The local contrast reduction function LC and/or local de-saturation function LD serve to allow a larger gain to be set by the feedback loop, thereby allowing brighter images in case of images for which the white clipping is operational, and stronger backlight dimming, so better reproduction of the low gray levels, if the backlight dimming is operational.

As also shown in FIG. 6, the output of the amplifier A is coupled to the input of the local desaturation function LD, the output of the local desaturation function LD is coupled to the input of the local contrast reduction function LC, the output signal V2 of the local contrast reduction function LC is coupled to the input of the detector S. Optionally the output signal V2 is coupled via a first gamma corrector GA1 to the display panel DP. The first gamma corrector GA1 is adapted to correct for any mismatch between the pre-corrected gamma function of the input signal and any non-linear characteristics of any subsequent driver circuitry or of the display panel DP deviating from this pre-corrected gamma function. The first gamma corrector GA1 may also be adapted to maintain a desired degree of non-linearity to enhance the perceived quality of the displayed image.

The detector S comprises a first detector S1 for detecting the number of pixels exceeding the first predetermined level x1. This number is compared in the comparator D1 with the first predetermined number n1 and the resulting difference is coupled to the control circuit CM. A suitable value for the number n1 for this embodiment is one percent of the number of pixels in an image.

The control circuit CM adapts the gain of the amplifier A based on the resulting difference received from the comparator D1. If the gain has to be set to a relatively low value (which is still at least one), implying that white clipping is taking place, a control signal is supplied to the light source LS to keep the light source LS on its maximum level. If the gain has to be set to a relatively high value, implying that backlight dimming is operational, then the light source LS is dimmed via its control signal to compensate for the high value of the gain, which results in a higher transmissivity of the display panel DP. If a user contrast setting UC function has to be available, this function should preferably be coupled to the control circuit CM. Via this control circuit CM, the contrast may be reduced by dimming the light source LS. The result is an observed contrast reduction as the peak brightness is reduced. So, basically the gain of the amplifier is always kept at its highest possible value, which corresponds to the maximum transmissivity of the display panel DP. Only if it has to be possible that the contrast can be reduced further even if the light source LS has reached its minimum value, the gain of the amplifier A should be reduced to further reduce the contrast. Part of a dynamic range from a minimum value to a maximum value of the brightness level of the light source LS may be reserved for the user contrast setting UC while the remainder is usable for the backlight dimming operation. Generally, this is desirable as else the fluctuations of the dimming depending on the image content may become too large and may cause disturbances when viewing a sequence of changing images. Optionally, the user contrast setting UC may influence which part of the dynamic range is available for backlight dimming.

An ambient light sensor ALS may be present for detecting the ambient light level as shown in FIG. 6. An output of the ambient light sensor ALS is coupled to the control circuit CM. In dependence on the ambient light level the contrast setting may be adapted. In this case, preferably the part of the dynamic range reserved for the user contrast setting UC is also available for contrast settings in dependence on the ambient light level.

A temperature sensor TS, for example a temperature dependent resistor, may be present, as shown in FIG. 6 for sensing the ambient temperature of the product PR, the display device DD, the temperature of the light source LS, the temperature of a lamp of the light source LS, and/or the temperature of another component inside the product PR. It is advantageous, if the temperature sensor TS senses the temperature of the cold spot of the lamp, as this is an important parameter related to the efficiency of the lamp. An output of the temperature sensor TS, is coupled to the processor P, for example to the control circuit CM, for influencing the light output of the light source LS. This may be realized via a look-up table or other hardware or software for converting temperature information into a setting for the backlight dimming or for limiting the available range for backlight dimming.

Alternatively, a simple feedback loop is present, which compares the sensed temperature of the light source LS or a component of the light source LS (or a signal derived from this temperature) with a reference temperature indication. The loop increases an allowable highest level of the light output of the light source LS, if the sensed temperature is lower than the reference temperature indication and if the highest level does not exceed the maximum value. The loop decreases an allowable highest level of the light output of the light source LS if the sensed temperature is higher than the reference temperature indication. Preferably, the loop sets a power consumption level of the light source LS to a level, which is acceptable at the sensed temperature. With acceptable is meant that the product PR and its components operate within their specifications. By applying temperature controlled backlight dimming a fan or additional cooling measures, needed to keep components within its specifications at high ambient temperatures, can be avoided by reducing power consumption of the light source LS (and its related power supply and driving circuitry) under these high ambient temperature conditions.

The detector S may comprise additional circuitry for limiting an average brightness of a sequence of images to be displayed. This may be desirable to give an LCD device a behavior similar to a well-known cathode ray tube, which has also such limiting characteristics. Moreover if a light source LS is applied which is not capable of continuously providing its maximum output, this limiting circuitry reduces the percentage of time that the light source LS is operated at its maximum output ratings, so on an average power is saved in dependence on the image content. In order to obtain a signal from the output signal V2 that is proportional to the brightness of the display panel DP, it is necessary to correct for any non-linearity in the chain from the output signal V2 to the emitted light from the display panel DP. A second gamma corrector GA2 does this correction. The resulting output signal of the second gamma corrector GA2 is supplied to an average power detector AP. By averaging this signal over a predetermined period, for example, corresponding to a period for displaying one or more images, a signal is obtained corresponding to the average power. This signal may be compared in a second comparator D2 with a reference power level RP. If this signal is larger than the reference power level RP, then via the control circuit CM the contrast is reduced, for example by an operation similar to backlight dimming.

The detector S as described in relation to any of the earlier mentioned embodiments may use only a part of the image for detecting a property. This part may, for example, exclude subtitles, other text superimposed on a moving image, or other very small and relatively white details, such as logos or other highlights. This may be done by excluding areas having a dimension below a predetermined dimension. Such a dimension may be a length or a width of the area, or the size of the area or a combination of these dimensions, for example as explained in relation to the white clipping, optionally with weighting factors.

The feedback loop formed by the amplifier A, the detector S and the control circuit CM may comprise a low pass filter function for restricting changes of the gain for subsequent images. This may be realized, for example, by applying a low pass filter between the output of the comparator D1 and the control circuit CM. In case of a hardware execution it may be a well-known low-pass filter. In case of a software execution the function may be obtained by averaging the required change over a number of subsequent images in the control circuit CM.

The averaging may be set to respond faster during an increase of the output light of the light source LS for subsequent images as result of white areas following a sequence of dark images. The advantage is, that clipping in white areas is reduced for images with white areas following the sequence of dark images. At the same time a relatively slow response during a decrease of the output light of the light source LS as result of a sequence of dark images following a sequence of images with white areas, ensures that flickering of the displayed image is avoided. This has as additional advantage that the relatively slow response of backlight dimming allows the eyes of a viewer to accommodate to the darker images. Moreover, undesired flickering effects are avoided with this relatively slow response for sequences of images having strongly varying gray levels from dark to white levels.

The averaging may also take into account lamp parameters, for example at what rate a lamp is able to change its light output, any limitations required to ensure an adequate lifetime of a lamp, or actual operating conditions or historical operating conditions of a lamp.

If the output signal V2 comprises at least two color components, there are various options to detect the first number of pixels exceeding the first predetermined number:

The first number of pixels exceeding the first predetermined gray level is counted by counting all pixels (or sub-pixels) in the part of the image independent of their color.

For each pixel, having sub-pixels corresponding to the color components, the gray value of the color component with the highest gray value is selected and this particular value is used by the detector S for the counting.

For each color component a separate counter is present in the detector for detecting the second number of pixels exceeding the first predetermined gray level. This results in a second number for each of the color components. The highest of these second numbers is selected as the first number. This approach ensures that the white clipping or backlight dimming operates correctly without allowing one of the color components to have already a substantially clipping before the gain of the amplifier A is reduced.

In FIG. 7 an automatic gain setting GS as function of a user gain UG set by a user is shown for an embodiment as shown in FIG. 1. If the user sets the user gain UG to one, then the output signal V2 is not clipped, and the range of gray levels of the input signal V1, for example from zero to 255, results in driving the display panel DP from its minimum transmissivity to its maximum transmissivity. If the user gain is set above one, then without white clipping reduction means CRM, the gain setting GS would have the same value above one with as consequence that gray levels near the level 255 are all clipped to the maximum level of 255. If white clipping reduction means CRM are present, the gain setting is reduced by the feedback loop if the input signal V1 contains gray values near 255. If the input signal V1 contains many pixels with gray levels of 255 then the gain setting has to be reduced to one in order to avoid clipping. This is illustrated in FIG. 7 with the arrows pointing downwards to a gain setting of one. If the highest gray level of the input signal V1 is below 255, a gain setting GS above one is allowed to such an extent that the highest gray level of the input signal V1, when multiplied with this gain setting GS, results in a gray level which is just not clipped. So, as result of the white clipping reduction, the gain setting GS may obtain a value, depending on the gray levels of the input signal V1, indicated by area CR in FIG. 7, when the user gain UG is set between one and two.

If the input signal V1 comprises gray levels which are far below the maximum level of 255, then the backlight dimming increases the gain setting GS up to a level where clipping starts. This is indicated for various user gain UG settings by arrows pointing upward. How much the gain setting GS is increased by the backlight dimming with respect to the user gain UG, depends on the gray levels of the input signal V1. The area of resulting gain setting GS is indicated with BLD. For user gain UG settings below a first user gain UG1 the upper limit of the gain setting GS depends on the user gain setting UG. For user gain UG settings above the first user gain setting UG1, the upper limit is fixed (in this example at two, in general a value between two and three has been found to be suitable). For values of the user gain UG below the first user gain setting UG1, the maximal obtainable gain setting is preferably dependent on the maximum available dimming ratio of the light source.

It should be noted that the above-mentioned embodiments illustrate rather than limit the invention, and that those skilled in the art will be able to design many alternative embodiments without departing from the scope of the appended claims. For example, the allocation of the features in the various blocks of software or hardware may be changed without departing from the scope of the appended claims. Embodiments as shown in FIG. 1, FIG. 5 and FIG. 6 may also have more than one amplifier A as shown in FIG. 4 and/or more than one feedback loop, for example one feedback loop for each color component. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A display device (DD) comprising a light source (LS); a display panel (DP) with display pixels for modulating light originating from the light source (LS); and processing means (P) coupled to the display panel (DP) and the light source (LS), the processing means (P) having an input for receiving an input signal (V1) representing gray levels of pixels of an image to be displayed on the display panel (DP) and comprising:
means for amplifying (A) the input signal (V1) to provide an output signal (V2) for driving the display pixels,
means for detecting (S) within a part of the image a property of the output signal (V2), and
control means (CM) for controlling a gain of the amplifying means (A) and a brightness level of the light source (LS) in dependence on the property.

2. A display device (DD) as claimed in claim 1, the property being a first number of pixels of the output signal (V2) exceeding a first predetermined number, the first number of pixels being the number of pixels having a gray level exceeding a first predetermined gray level.

3. A display device (DD) as claimed in claim 1, the control means (CM) being adapted to control the brightness level of the light source (LS) so as to substantially compensate for a change in brightness of a displayed image resulting from a change of the gain.

4. A display device (DD) as claimed in claim 1, the processing means (P) further comprising white clipping reduction means (CRM), the input signal (V1) being coupled to the white clipping reduction means (CRM) for reducing clipping of the input signal (V1), an output of the white clipping reduction means (CRM) being coupled to the amplifying means (A).

5. A display device (DD) as claimed in claim 1, the processing means (P) further being adapted to perform white clipping with the amplifying means (A), the detecting means (S), and the control means (CM).

6. A display device (DD) as claimed in claim 2, the detecting means (S) being adapted for detecting a second number of pixels of the output signal (V2) having a gray level exceeding a second predetermined gray level which is lower than the first predetermined gray level, the control means (CM) being adapted for decreasing the gain of the amplifying means (A) if the first number of pixels exceeds the first predetermined number, and increasing the gain if the second number of pixels is below a second predetermined number.

7. A display device (DD) as claimed in claim 1, wherein the part of the image excludes areas having a dimension below a predetermined dimension.

8. A display device (DD) as claimed in claim 1, the control means (CM) including filtering means for restricting changes of the gain for subsequent images to be displayed.

9. A display device (DD) as claimed in claim 2, the input signal (V1) comprising at least two color components, the detecting means (S) being adapted to detect a second number of pixels of the output signal (V2) having a gray level exceeding the first predetermined gray level for each of the at least two color components, and to select as the first number the highest of the second numbers.

10. A display device (DD) as claimed in claim 1, the light source (LS) comprising lamps having mutually different colors, the input signal (V1) comprising color components, the control means (CM) being adapted to control the brightness level of the light source (LS) by separately controlling a brightness level of one or more of the lamps, and the processing means (P) further comprising means for correcting the color components to substantially compensate for a color point shift of the displayed image as caused by separately controlling the brightness level of one or more of the lamps.

11. A display device (DD) as claimed in claim 1, the processing means further including soft clipping for reducing contrast of the input signal (V1) in an area of the image.

12. A display device (DD) as claimed in claim 1, the brightness level of the light source (LS) being adjustable in a range between a minimum value and a maximum value, wherein part of the range is usable for adjustments by a user and another part of the range is usable for controlling the brightness level of the light source (LS) in dependence on the property.

13. A display device (DD) as claimed in claim 1, comprising an ambient light sensor for enabling the controlling of the brightness level of the light source (LS) in dependence on an ambient light level.

14. A display device (DD) as claimed in claim 1, the processing means comprising gamma correction means for compensating non-linear characteristics of the display device (DD) and/or of the input signal (V1).

15. A method of adjusting a light source (LS) of a display device (DD), the display device (DD) comprising a display panel (DP) with display pixels for modulating light originating from the light source (LS), the method comprising:
receiving an input signal (V1) representing gray levels of pixels of an image to be displayed on the display panel (DP),
amplifying (A) the input signal (V1) to provide an output signal (V2) for driving the display pixels,
detecting (S) within a part of the image a property of the output signal (V2),
controlling (CM) a gain of the amplifying (A) and a brightness level of the light source (LS) in dependence on the property.

16. A product (PR) comprising the display device (DD) as claimed in claim 1, and signal processing circuitry (SPC) for providing the input signal (V1).

17. An integrated circuit (P) having:
an input for receiving an input signal (V1) representing gray levels of pixels of an image to be displayed on a display panel (DP) of a display device (DD), the display device (DD) comprising an adjustable light source (LS), the display panel (DP) having display pixels for modulating light originating from the light source (LS);
outputs for coupling to the display panel (DP) and the light source (LS); means for amplifying (A) the input signal (V1) to provide an output signal (V2) for driving the display pixels,
means for detecting (S) within a part of the image a property of the output signal (V2), and
control means (CM) for controlling a gain of the amplifying means (A) and a brightness level of the light source (LS) in dependence on the property.

18. A computer program product for enabling a programmable device to carry out the method of claim 15.
